(19) United States
(12) Patent Application Publication
(10) Pub. No.: US 2026/0253461 A1
(43) Pub. Date: Aug. 27, 2026

(54) DETERMINATION DEVICE, DETERMINATION METHOD, AND STORAGE MEDIUM

(71) Applicant: HONDA MOTOR CO., LTD., Tokyo (JP)

(72) Inventors: Renji Kuriyama, Tokyo (JP); Shinya Sato, Tokyo (JP); Masatoshi Saito, Yokohama-shi (JP)

(21) Appl. No.: 19/531,715

(22) Filed: Feb. 6, 2026

(30) Foreign Application Priority Data
Feb. 25, 2025 (JP) 2025-028241

(51) Int. Cl. G07C 5/04

(52) U.S. Cl. CPC G07C 5/04

(57) ABSTRACT

A determination device includes a storage medium storing computer-readable instructions and a processor connected to the storage medium. The processor executes the computer-readable instructions to calculate a first vehicle speed of a vehicle based on a vehicle speed of the vehicle, calculate a second vehicle speed that is an estimated speed of the vehicle based on a past value of the calculated first vehicle speed and acceleration of the vehicle, and determine which of the first vehicle speed and the second vehicle speed is to be adopted as the vehicle speed of the vehicle. The processor adopts the second vehicle speed as the vehicle speed when all wheels of the vehicle are locked due to braking applied to the vehicle and subsequently adopts the first vehicle speed based on wheel speeds of rear wheels of the vehicle as the vehicle speed of the vehicle when the wheels tend to unlock.

### CROSS-REFERENCE TO RELATED APPLICATION

This application is based upon and claims the benefit of priority from Japanese Patent Application No. 2025-028241, filed February 25, 2025, the entire contents of which is incorporated herein by reference.

### BACKGROUND

### Field of the Invention

The present invention relates to a determination device, a determination method, and a storage medium.

### Description of Related Art

Conventionally, techniques for estimating a vehicle speed of a vehicle when the wheels of the vehicle are locked during traveling due to slipping or the like are known. For example, Japanese Unexamined Patent Application, First Publication No. H08-043417 discloses a technique for selecting a smaller one of a variation in a lowest wheel speed among wheel speeds of four wheels and an acceleration of an integrated value of forward/rearward acceleration when the vehicle is accelerated and selecting a smaller one of a variation in a highest wheel speed and a deceleration of an integrated value of forward/rearward acceleration when the vehicle is decelerated.

In the technique described in Japanese Unexamined Patent Application, First Publication No. H08-043417, the vehicle speed is obtained by adopting either a variation in the wheel speed that is less affected by the lock or an integrated value of acceleration acquired from a G-sensor. However, in the above-described technique, because the wheel speed is basically adopted after the wheel is unlocked, the wheel speed may not be utilized early and with high accuracy for estimating the vehicle speed.

### SUMMARY OF THE INVENTION

The present invention has been made in view of such circumstances, and an objective thereof is to provide a determination device, a determination method, and a storage medium that enable a wheel speed to be utilized early and with high accuracy for estimating a vehicle speed when wheels of a vehicle are locked.

A determination device, a determination method, and a storage medium according to the present invention adopt the following configurations.

(1): According to an aspect of the present invention, there is provided a determination device including: a storage medium storing computer-readable instructions; and a processor connected to the storage medium, the processor executing the computer-readable instructions to: calculate a first vehicle speed of a vehicle based on a vehicle speed of the vehicle; calculate a second vehicle speed that is an estimated speed of the vehicle based on a past value of the calculated first vehicle speed and acceleration of the vehicle; and determine which of the first vehicle speed and the second vehicle speed is to be adopted as the vehicle speed of the vehicle, wherein the processor adopts the second vehicle speed as the vehicle speed when all wheels of the vehicle are locked due to braking applied to the vehicle and subsequently adopts the first vehicle speed based on wheel speeds of rear wheels of the vehicle as the vehicle speed of the vehicle when the wheels tend to unlock.

(2): In the above-described aspect (1), the processor adopts an average wheel speed of all rear wheels of the vehicle as the first vehicle speed based on the wheel speeds of the rear wheels of the vehicle.

(3): In the above-described aspect (1), the processor adopts the first vehicle speed based on the wheel speeds of the rear wheels of the vehicle as the vehicle speed of the vehicle when only the rear wheels of the vehicle are locked due to the braking applied to the vehicle, all wheels of the vehicle are subsequently locked, and the wheels subsequently tend to unlock.

(4): In the above-described aspect (1), the processor determines that the wheels tend to unlock to adopt the first vehicle speed based on the wheel speeds of the rear wheels of the vehicle as the vehicle speed of the vehicle when the first vehicle speed based on the wheel speeds of the rear wheels of the vehicle is greater than or equal to the second vehicle speed.

(5): In the above-described aspect (1), the processor calculates the second vehicle speed of the vehicle from the past value of the first vehicle speed before all wheels of the vehicle are locked and the acceleration of the vehicle, and the processor adopts the vehicle speed based on the wheel speeds of the rear wheels of the vehicle as the first vehicle speed based on the wheel speeds of the rear wheels of the vehicle when the wheels tend to unlock from a state in which all wheels of the vehicle are locked.

(6): According to another aspect of the present invention, there is provided a determination device including: a storage medium storing computer-readable instructions; and a processor connected to the storage medium, the processor executing the computer-readable instructions to: calculate a first vehicle speed of a vehicle based on a vehicle speed of the vehicle; calculate a second vehicle speed that is an estimated speed of the vehicle based on a past value of the calculated first vehicle speed and acceleration of the vehicle; and determine which of the first vehicle speed and the second vehicle speed is to be adopted as the vehicle speed of the vehicle, wherein the processor adopts the second vehicle speed as the vehicle speed when all wheels of the vehicle spin due to the acceleration of the vehicle and subsequently adopts the first vehicle speed based on wheel speeds of front wheels of the vehicle as the speed of the vehicle when the spin tends to be released.

(7): According to yet another aspect of the present invention, there is provided a determination method including: calculating, by a computer, a first vehicle speed of a vehicle based on a vehicle speed of the vehicle; calculating, by the computer, a second vehicle speed that is an estimated speed of the vehicle based on a past value of the calculated first vehicle speed and acceleration of the vehicle; determining, by the computer, which of the first vehicle speed and the second vehicle speed is to be adopted as the vehicle speed of the vehicle; and adopting, by the computer, the second vehicle speed as the vehicle speed when all wheels of the vehicle are locked due to braking applied to the vehicle and subsequently adopting the first vehicle speed based on wheel speeds of rear wheels of the vehicle as the vehicle speed of the vehicle when the wheels tend to unlock.

(8): According to yet another aspect of the present invention, there is provided a computer-readable non-transitory storage medium storing a program for causing a computer to: calculate a first vehicle speed of a vehicle based on a vehicle speed of the vehicle; calculate a second vehicle speed that is an estimated speed of the vehicle based on a past value of the calculated first vehicle speed and acceleration of the vehicle; determine which of the first vehicle speed and the second vehicle speed is to be adopted as the vehicle speed of the vehicle; and adopt the second vehicle speed as the vehicle speed when all wheels of the vehicle are locked due to braking applied to the vehicle and subsequently adopt the first vehicle speed based on wheel speeds of rear wheels of the vehicle as the vehicle speed of the vehicle when the wheels tend to unlock.

According to the aspect (1), by taking into account that load transfer during braking applied to the vehicle with all wheels locked tends to restore the grip of the rear wheels, the wheel speed can be obtained from the rear wheels during a tendency to unlock, such that it is possible to utilize the wheel speed early and with high accuracy for estimating the vehicle speed.

According to the aspect (2), by obtaining the vehicle speed based on the average wheel speed of all rear wheels, a variation during the tendency of unlocking can be prevented in advance.

According to the aspect (3), in a situation in which the rear wheels are locked and then the front wheels also slip, temporarily increasing the grip of the rear wheels, the wheel speed is obtained from the rear wheels based on the determination that there is a high possibility that the rear wheels will be unlocked first, and the wheel speed can be utilized early and with high accuracy to estimate the vehicle speed.

According to the aspects (4) and (5), when all wheels of the vehicle are locked, the actual vehicle speed is higher than the estimated vehicle speed estimated from the vehicle speed (past value) and deceleration at the time of braking without all-wheel lock. Subsequently, the rear wheel speed at the time of a tendency to unlock becomes closer to the actual vehicle speed than to the estimated vehicle speed, enabling accurate determination of the unlocking tendency.

According to the aspect (6), by taking into account that load transfer tends to restore the grip of the front wheels when the vehicle is accelerated and all wheels spin, the wheel speed can be obtained from the front wheels during a tendency of release from the spin, thereby utilizing the wheel speed early and with high accuracy for estimating the vehicle speed.

### BRIEF DESCRIPTION OF THE DRAWINGS

FIG. 1 is a diagram showing an example of a configuration of a vehicle system on which a vehicle control device is mounted according to an embodiment.

FIG. 2 is an explanatory diagram of state transitions of a host vehicle and an adopted vehicle speed when all wheels of the host vehicle M are locked due to braking applied to the host vehicle.

FIG. 3 is an explanatory diagram of a state transition of the host vehicle and an adopted vehicle speed when all wheels of the host vehicle spin due to acceleration of the host vehicle.

FIG. 4 is a flowchart showing an example of a flow of a process executed by a determination device during braking applied to the host vehicle.

FIG. 5 is a flowchart showing an example of a continuation of the flow of the process of the flowchart of FIG. 4.

### DESCRIPTION OF EMBODIMENTS

Hereinafter, embodiments of a determination device, a determination method, and a storage medium of the present invention will be described with reference to the drawings. In addition, it is assumed that the determination device of the embodiment is mounted on a vehicle. The vehicle is a vehicle such as a four-wheeled vehicle, and a drive source thereof is an internal combustion engine such as a diesel engine or a gasoline engine, an electric motor, or a combination thereof. The electric motor operates using electric power generated by a power generator connected to the internal combustion engine or electric power when a secondary battery or a fuel cell is discharged.

### Overall configuration

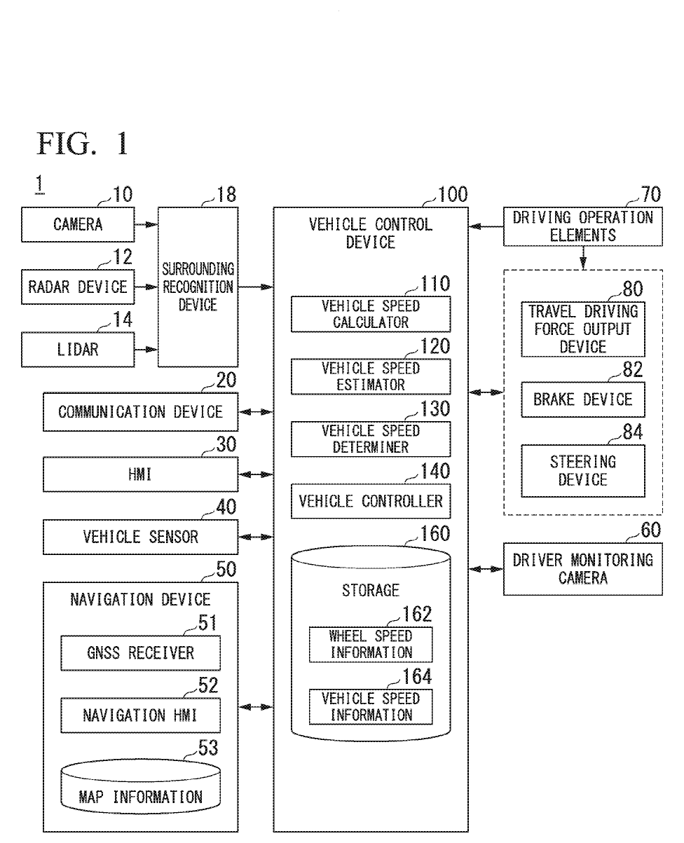

FIG. 1 is a diagram showing an example of a configuration of a vehicle system 1 on which the vehicle control device is mounted according to the present embodiment. For example, the vehicle system 1 shown in FIG. 1 includes a camera 10, a radar device 12, a light detection and ranging (LIDAR) 14, a surrounding recognition device 18, a communication device 20, a human machine interface (HMI) 30, a vehicle sensor 40, a navigation device 50, a driver monitoring camera 60, driving operation elements 70, a travel driving force output device 80, a brake device 82, a steering device 84, and a vehicle control device 100. Such devices and equipment are connected to each other by a multiplex communication line such as a controller area network (CAN) communication line, a serial communication line, or a wireless communication network. The configuration shown in FIG. 1 is merely an example and some of the constituent elements may be omitted or other constituent elements may be further added.

For example, the camera 10 is a digital camera using a solid-state imaging element such as a charge-coupled device (CCD) or a complementary metal-oxide semiconductor (CMOS). One or more cameras 10 are attached to any location on a vehicle (hereinafter, a host vehicle M) on which the vehicle system 1 is mounted. For example, when the view in front of the host vehicle M is imaged, the camera 10 is attached to an upper part of a front windshield, a rear surface of a rearview mirror, or the like. When the view to the rear of the host vehicle M is imaged, the camera 10 is attached to an upper part of a rear windshield, a back door, or the like. Moreover, when the views to the side and the rear side of the host vehicle M are imaged, the camera 10 is attached to a door mirror or the like. For example, the camera 10 periodically and iteratively images the surroundings of the host vehicle M. The camera 10 may be a stereo camera.

The camera 10 further includes a fisheye camera capable of imaging the surroundings of the host vehicle M at a wide angle (e.g., 360 degrees). The fisheye camera is, for example, attached to an upper part of the host vehicle M and images the surroundings of the host vehicle M at a wide angle in the horizontal direction. The fisheye camera may also be implemented by combining a plurality of cameras (a plurality of cameras that image a range of 120 degrees or 60 degrees in the horizontal direction).

The radar device 12 radiates radio waves (radar) such as millimeter waves around the host vehicle M and detects at least a position of a physical object (a distance from the physical object and a direction of the physical object) by detecting radio waves (reflected waves) reflected by the physical object near the host vehicle M. One or more radar devices 12 are attached to any location on the host vehicle M. The radar device 12 may detect a position and a speed of the physical object in a frequency-modulated continuous wave (FM-CW) scheme.

The LIDAR 14 radiates light (or electromagnetic waves having a wavelength close to light) to the vicinity of the host vehicle M and measures scattered light. The LIDAR 14 detects a distance from an object based on a period of time from light emission to light reception. The radiated light is, for example, pulsed laser light. The LIDAR 14 is attached to any location on the host vehicle M.

A surrounding recognition device 18 performs a sensor fusion process on detection results of some or all of the constituent elements of external environment sensors (e.g., the camera 10, the radar device 12, and the LIDAR 14), and recognizes positions, types, speeds, and the like of physical objects in the surroundings of the host vehicle M. Examples of the physical objects include other vehicles (e.g., nearby vehicles located within a predetermined distance from the host vehicle M), pedestrians, bicycles, road structures, and the like. Examples of the road structures include road signs, traffic signals, curbs, median strips, guardrails, fences, walls, railroad crossings, and the like. The surrounding recognition device 18 outputs recognition results to the vehicle control device 100. In addition, the surrounding recognition device 18 may output detection results of the external environment sensors to the vehicle control device 100 as they are. In such a case, the surrounding recognition device 18 may be omitted from the configuration of the vehicle system 1. Alternatively, the surrounding recognition device 18 may be included in the vehicle control device 100.

The communication device 20, for example, communicates with another vehicle located in the vicinity of the host vehicle M, a terminal device of a user using the host vehicle M, or various types of server devices using, for example, a cellular network, a Wi-Fi network, Bluetooth (registered trademark), dedicated short-range communication (DSRC), a local area network (LAN), a wide area network (WAN), a network such as the Internet, or the like.

The HMI 30 presents various types of information to a user of the host vehicle M and receives input operations from the user. Examples of the user include occupants such as a driver who drives the host vehicle M and passengers. Hereinafter, unless otherwise specified, they will be collectively referred to as “occupants.” The HMI 30 includes, for example, a display, a speaker, and a turn-signal switch. Moreover, the HMI 30 may include a buzzer, a touch panel, switches, keys, a microphone, and the like.

The vehicle sensor 40 includes a wheel speed sensor that detects the number of rotations per unit time of the wheel of the host vehicle M and outputs, as a sensor value, a wheel speed pulse count indicating the detected number of rotations; an acceleration sensor (G-sensor) that detects acceleration; a yaw-rate sensor that detects a yaw rate (e.g., a rotational angular velocity about a vertical axis passing through the center of gravity of the host vehicle M); a direction sensor that detects a direction of the host vehicle M; an inclination sensor that detects an inclination angle of a road surface on which the host vehicle M is located; a seat sensor that detects a load on a seat of the host vehicle M; a door sensor that detects an open state of a door of the host vehicle M; and the like. Moreover, the vehicle sensor 40 may include a position sensor configured to detect the position of the host vehicle M. The position sensor is, for example, a sensor configured to acquire position information (longitude/latitude information) from a Global Positioning System (GPS) device. Moreover, the position sensor may be, for example, a sensor configured to acquire position information using a global navigation satellite system (GNSS) receiver 51 to be described below. A detection result of the vehicle sensor 40 is output to the vehicle control device 100.

For example, the navigation device 50 includes the GNSS receiver 51 and a navigation HMI 52. The navigation device 50 stores map information 53 in a storage device such as a hard disk drive (HDD) or a flash memory. The GNSS receiver 51 identifies a position of the host vehicle M based on a signal received from a GNSS satellite. The position of the vehicle M may be identified or complemented by an inertial navigation system (INS) using an output of the vehicle sensor 40. The navigation HMI 52 includes a display device, a speaker, a touch panel, a key, and the like. The navigation HMI 52 may be partly or wholly shared with the above-described HMI 30. The navigation device 50, for example, decides, with reference to the map information 53, a route from a position of the vehicle M identified by the GNSS receiver 51 (or from any input position) to a destination input by the occupant using the navigation HMI 52.

The navigation device 50 further cooperates with the vehicle control device 100, to be described below, to provide an automatic parking function for parking the host vehicle M in an unmanned state. Functional parts provided by the navigation device 50 for implementing the automatic parking function will be described below.

The map information 53 is, for example, information in which a road shape is expressed by a link indicating a road (an example of a movement path) and nodes connected by the link. The map information 53 may include the curvature of a road, point of interest (POI) information, and the like. Moreover, the map information 53 may include, for example, information about the center of a lane or information about lane boundaries (road markings), and the like. Moreover, the map information 53 may further include road information, traffic regulation information, address information (addresses and postal codes), facility information, telephone number information, and the like. The map information 53 may be updated as needed by the communication device 20 communicating with another device. Moreover, the map information 53 may be stored in a storage 160 to be described below.

The driver monitoring camera 60 is, for example, a digital camera using a solid-state imaging device such as a CCD or a CMOS. The driver monitoring camera 60 is mounted on any location in the host vehicle M in a position and direction that enable imaging of the head and upper body of the driver sitting in the driver’s seat from the front (i.e., in a direction in which the driver’s face is imaged). For example, the driver monitoring camera 60 may be mounted on an upper part of a display device provided at a central part of an instrument panel of the host vehicle M, on an upper part of a front windshield, on a room mirror, or the like. For example, the driver monitoring camera 60 periodically and iteratively captures images including the driver. Moreover, the driver monitoring camera 60 may additionally capture images including passengers in the vehicle cabin, in addition to the driver.

The driving operation elements 70, for example, includes various types of operation elements such as a steering wheel to be operated by the driver for steering, an accelerator pedal, a brake pedal, and a shift lever. An operation detector that detects an operation amount performed by the driver is, for example, mounted on each operation element of the driving operation elements 70. The operation detector detects an amount of depression of the accelerator pedal or the brake pedal, a position of the shift lever, a steering angle or steering torque of the steering wheel, and the like. Also, the operation detector outputs a detection signal indicating the detection result to the vehicle control device 100 or one or some of the travel driving force output device 80, the brake device 82, and the steering device 84.

The travel driving force output device 80 outputs a travel driving force (torque) for enabling the traveling of the host vehicle M to driving wheels. For example, the travel driving force output device 80 includes a combination of an internal combustion engine, an electric motor, a transmission, and the like, and a power electronic control unit (ECU) that controls the internal combustion engine, the electric motor, the transmission, and the like. The power ECU controls the above-described constituent elements in accordance with information input from the vehicle control device 100 or information input from the accelerator pedal of the driving operation element 70.

For example, the brake device 82 includes a brake caliper, a cylinder configured to transfer hydraulic pressure to the brake caliper, an electric motor configured to generate hydraulic pressure in the cylinder, and a brake ECU. The brake ECU controls the electric motor in accordance with the information input from the vehicle control device 100 or the information input from the driving operation element 70 so that brake torque according to a braking operation is output to each wheel. The brake device 82 may include a mechanism configured to transfer the hydraulic pressure generated according to an operation on the brake pedal included in the driving operation elements 70 to the cylinder via a master cylinder as a backup. In addition, the brake device 82 is not limited to the above-described configuration and may be an electronically controlled hydraulic brake device configured to control an actuator in accordance with information input from the vehicle control device 100 and transfer the hydraulic pressure of the master cylinder to the cylinder.

For example, the steering device 84 includes a steering ECU and an electric motor. For example, the electric motor changes directions of steerable wheels by applying a force to a rack and pinion mechanism. The steering ECU drives the electric motor in accordance with the information input from the vehicle control device 100 or the information input from the steering wheel that is the driving operation element 70 to change the directions of the steerable wheels.

### Configuration of vehicle control device 100

The vehicle control device 100 includes, for example, a vehicle speed calculator 110, a vehicle speed estimator 120, a vehicle speed determiner 130, a vehicle controller 140, and a storage 160. The vehicle speed calculator 110, the vehicle speed estimator 120, the vehicle speed determiner 130, and the vehicle controller 140 are each implemented, for example, by a hardware processor such as a central processing unit (CPU) executing a program (software). Moreover, some or all of the above constituent elements may be implemented by hardware (including a circuit; circuitry) such as a large-scale integration (LSI) circuit, an application-specific integrated circuit (ASIC), a field-programmable gate array (FPGA), or a graphics processing unit (GPU) or may be implemented by software and hardware in cooperation. The above-described program may be pre-stored in the storage device (a storage device including a non-transitory storage medium) such as an HDD or a flash memory of the vehicle control device 100 or may be stored in a removable storage medium such as a DVD, a CD-ROM, or a memory card and installed in the storage device of the vehicle control device 100 when the storage medium (the non-transitory storage medium) is mounted in a drive device, a card slot, or the like. In the storage 160, wheel speed information 162 and vehicle speed information 164 are stored. The wheel speed information 162 is information in which wheel speed pulse counts output by a wheel speed sensor included in the vehicle sensor 40 are stored in a time series. The storage 160 is, for example, an HDD, a flash memory, a random-access memory (RAM), or the like. A combination of the vehicle speed calculator 110, the vehicle speed estimator 120, and the vehicle speed determiner 130 is an example of a “determination device” in the claims, and the determination device may be implemented independently of the vehicle control device 100.

### Calculation of vehicle speed

The vehicle speed calculator 110 calculates a vehicle speed of the host vehicle M based on the wheel speed information 162 stored in the storage 160. For example, the vehicle speed calculator 110 may calculate the vehicle speed (wheel speed) of the host vehicle M by substituting the wheel speed pulse count stored in the wheel speed information 162 into a conversion formula representing a relationship between the wheel speed pulse count and the vehicle speed. While the host vehicle M is traveling, the vehicle speed calculator 110 may calculate the vehicle speed of the host vehicle M from the wheel speed pulse count of a specific wheel (e.g., one of the front wheels or one of the rear wheels), or may calculate respective vehicle speeds from wheel speed pulse counts of a plurality of wheels and calculate the vehicle speed of the host vehicle M as an average value thereof. The vehicle speed calculator 110 stores, as the vehicle speed information 164, the calculated vehicle speed in a time series for a predetermined period. Hereinafter, the vehicle speed calculated by the vehicle speed calculator 110 may be referred to as a “first vehicle speed.”

The vehicle controller 140 executes automated driving or driving assistance of the host vehicle M based on the first vehicle speed calculated by the vehicle speed calculator 110. More specifically, for example, when the vehicle controller 140 executes automated driving, the vehicle controller 140 causes the travel driving force output device 80 to output a travel driving force to the wheels so that the calculated first vehicle speed matches a target speed defined in conjunction with an automatically generated target trajectory. Moreover, for example, when the vehicle controller 140 executes driving assistance, the vehicle controller 140 determines whether or not the first vehicle speed of the host vehicle M exceeds a speed threshold required for executing driving assistance such as a lane keeping assist system (LKAS) or adaptive cruise control (ACC). When it is determined that the calculated first vehicle speed exceeds the speed threshold, the vehicle controller 140 executes driving assistance such as LKAS or ACC.

### Estimation of vehicle speed during all-wheel lock

As described above, while the host vehicle M is traveling, the vehicle speed calculator 110 calculates the first vehicle speed of the host vehicle M based on the wheel speed information 162, and the vehicle controller 140 utilizes the calculated first vehicle speed for automated driving or driving assistance of the host vehicle M. However, for example, when all wheels become locked during traveling of the host vehicle M due to a slip or the like (i.e., when rotation is stopped), a deviation between the first vehicle speed based on the wheel speed information 162 and the actual vehicle speed increases, and the accuracy of the first vehicle speed deteriorates.

In this case, it is conceivable to estimate the vehicle speed of the host vehicle M by extrapolation using past values of the first vehicle speed. However, in the conventional technique, even if there is a wheel that is tending to restore from slip (i.e., a wheel that tends to unlock), a process for determining the lock of all wheels continues, and a time lag may occur in the return of the vehicle speed estimation based on the wheel speed information 162. As a result, when the wheels of the host vehicle M are locked, the wheel speed may not be able to be utilized early and with high accuracy for estimating the vehicle speed.

Under these circumstances, in the present embodiment, when all wheels of the host vehicle M are locked, the vehicle speed estimator 120 adopts, as the vehicle speed of the host vehicle M, a vehicle speed estimated by extrapolation while there is no wheel that tends to unlock. On the other hand, when there is a wheel that tends to unlock, the vehicle speed estimator 120 adopts, as the vehicle speed of the host vehicle M, a vehicle speed based on the wheel speed of that wheel, and the adopted vehicle speed is used for a control process of the vehicle controller 140. Details of the present embodiment will be described below.

The vehicle speed estimator 120 calculates an estimated vehicle speed according to acceleration of the host vehicle M based on a past value of the calculated first vehicle speed and the acceleration of the host vehicle M. More specifically, the vehicle speed estimator 120 calculates an estimated vehicle speed by adding a product of a past value of acceleration output by the acceleration sensor and an elapsed time after the acceleration is output to a past value of the first vehicle speed (more specifically, a past value before all-wheel lock) stored in the vehicle speed information 164 and by applying a time-series filter. Here, the time-series filter is used to address a tendency in which, as elapsed time from wheel lock becomes longer, the accuracy of the estimated vehicle speed based on past values before lock deteriorates. More specifically, the time-series filter evaluates the estimated vehicle speed at a smaller value by assuming that acceleration decreases due to wheel lock as the elapsed time becomes longer after the wheels are locked. For example, the time-series filter may multiply a correction value greater than or equal to 0 and less than or equal to 1, whose magnitude decreases as the elapsed time becomes longer, by the estimated vehicle speed at a current time point (time point t). Moreover, for example, the time-series filter may multiply the correction value by a vehicle speed variation from a previous time point (time point t−1) to a current time point (time point t). In these cases, the correction value is a value whose magnitude decreases as time point t becomes later. Moreover, for example, the time-series filter may multiply the correction value by a vehicle speed variation from a lock start time point (time point t−k) to the current time point (time point t). In this case, the correction value is a value whose magnitude decreases as the elapsed time k becomes larger. The configuration of the time-series filter is not limited to multiplication, and it is only necessary to evaluate at least the estimated vehicle speed at lower values when the elapsed time from lock becomes longer. The vehicle speed estimator 120 stores, as the vehicle speed information 164, the estimated vehicle speed in a time series for a predetermined period. Hereinafter, the vehicle speed calculated by the vehicle speed estimator 120 may be referred to as a “second vehicle speed.”

The vehicle speed determiner 130 adopts, as the vehicle speed, the second vehicle speed estimated by the vehicle speed estimator 120 when all wheels of the host vehicle M become locked due to braking applied to the host vehicle M and subsequently adopts, as the vehicle speed of the host vehicle M, the first vehicle speed based on the wheel speeds of the rear wheels of the host vehicle M when the wheels tend to unlock. Here, the case where the wheels tend to unlock specifically refers to the case where the rear wheels tend to unlock. This is because a process in which braking applied to the host vehicle M causes the host vehicle M to slip and lock all wheels is a process in which the grip of the front wheels (frictional force with the road surface) first increases due to deceleration and the grip of the rear wheels decreases so that the rear wheels slip; the front wheels subsequently slip and all wheels slip; the slip of the front wheels subsequently increases the grip of the rear wheels; and the rear wheels tend to unlock before the front wheels are locked.

The vehicle speed determiner 130 determines whether or not the rear wheels tend to unlock based on, for example, a comparison between the first vehicle speed based on the wheel speed of the rear wheels of the host vehicle M and the second vehicle speed estimated by the vehicle speed estimator 120. More specifically, the vehicle speed determiner 130 determines whether or not the first vehicle speed based on the wheel speed of the rear wheels of the host vehicle M is greater than or equal to the second vehicle speed after all wheels of the host vehicle M become locked, determines that the rear wheels tend to unlock when it is determined that the first vehicle speed is greater than or equal to the second vehicle speed, and adopts the first vehicle speed as the vehicle speed of the host vehicle M. This is because, when all wheels are locked, the first vehicle speed based on the current wheel speed temporarily becomes lower than the second vehicle speed estimated based on past wheel speeds and acceleration; however, when the rear wheels tend to unlock, the first vehicle speed becomes greater than or equal to the second vehicle speed and thus becomes closer to the actual vehicle speed (which has not decelerated as much as expected due to the occurrence of slipping).

When the first vehicle speed based on the wheel speeds of the rear wheels of the host vehicle M is adopted as the vehicle speed of the host vehicle M, the vehicle speed determiner 130 may adopt the first vehicle speed based on the wheel speed of either one of the rear wheels as the vehicle speed of the host vehicle M, or may adopt the first vehicle speed based on the average wheel speed of all rear wheels as the vehicle speed of the host vehicle M. By adopting the first vehicle speed based on the average wheel speed as the vehicle speed of the host vehicle M, variations in the tendency of the unlocking between the two rear wheels can be absorbed, and the vehicle speed of the host vehicle M can be obtained stably.

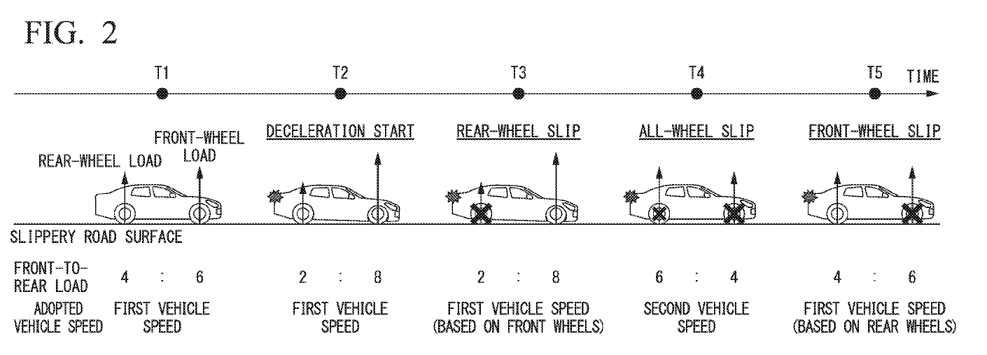

FIG. 2 is an explanatory diagram of a state transition of the host vehicle M and an adopted vehicle speed when all wheels of the host vehicle M become locked due to braking applied to the host vehicle M. First, at time point T1, the host vehicle M is assumed to be traveling on a slippery road surface. At this time, the front-to-rear load ratio of the rear wheels to the front wheels applied to the wheels of the host vehicle M is, for example, 4:6, and the vehicle speed determiner 130 adopts the first vehicle speed (not necessarily based on the rear wheels) as the vehicle speed of the host vehicle M. Subsequently, at time point T2, it is assumed that an occupant of the host vehicle M performs a braking operation and the host vehicle M begins to decelerate. At this time, the front-to-rear load ratio of the rear wheels to the front wheels is, for example, 2:8, and the vehicle speed determiner 130 adopts the first vehicle speed as the vehicle speed of the host vehicle M.

Subsequently, at time point T3, it is assumed that the rear wheels of the host vehicle M slip due to a low front-to-rear load proportion of the rear wheels. At this time, the front-to-rear load ratio of the rear wheels to the front wheels is, for example, 2:8, and the vehicle speed determiner 130 adopts the first vehicle speed based on the wheel speed of the front wheels of the host vehicle M as the vehicle speed of the host vehicle M. Subsequently, at time point T4, it is assumed that all wheels of the host vehicle M slip. At this time, the front-to-rear load ratio of the rear wheels to the front wheels is, for example, 6:4, and the vehicle speed determiner 130 adopts, for example, the second vehicle speed estimated based on past values of the first vehicle speed and acceleration before slip, as the vehicle speed of the host vehicle M.

The vehicle speed determiner 130 can determine whether or not each wheel has slipped based on the second vehicle speed and the first vehicle speed based on the wheel speed of each wheel. For example, the vehicle speed determiner 130 may calculate, as a slip determination value, a variation rate of the first vehicle speed based on the wheel speed of each wheel to the second vehicle speed (e.g., (second vehicle speed − first vehicle speed)/second vehicle speed) and determine that slip has occurred in the wheel when the slip determination value is greater than or equal to a slip determination threshold. This is because, when a certain wheel slips, the wheel speed of that wheel significantly decreases and the significantly decreased wheel speed causes the first vehicle speed based on the wheel speed to significantly decrease, resulting in a large deviation from the second vehicle speed, which is an estimated vehicle speed based on past values before the slip.

Subsequently, at time point T5, the slip of the rear wheels at time point T3 transitions to the slip of all wheels at time point T4, and the grip of the rear wheels of the host vehicle M increases due to the movement of the load from the front wheels to the rear wheels. At this time, because the front-to-rear load ratio of the rear wheels to the front wheels is, for example, 4:6, and the rear wheels of the host vehicle M tends to unlock, the vehicle speed determiner 130 adopts the first vehicle speed based on the wheel speeds of the rear wheels as the vehicle speed of the host vehicle M. At this stage, the first vehicle speed based on the wheel speeds of the rear wheels of the host vehicle M becomes greater than or equal to the second vehicle speed estimated based on past values of the first vehicle speed before the slip and acceleration, and becomes closer to the actual vehicle speed (which has not decelerated as much as expected due to the occurrence of slipping). That is, according to the present embodiment, when all wheels slip due to braking of the vehicle, the wheel speed can be utilized early and with high accuracy for estimating the vehicle speed by obtaining the wheel speed from the rear wheels when the wheels tend to unlock.

Although the state transition of the host vehicle M and the adopted vehicle speed when all wheels of the host vehicle M become locked due to braking applied to the host vehicle M are shown in FIG. 2, the state transition of the host vehicle M and the adopted vehicle speed when all wheels of the host vehicle M spin (i.e., the wheel speed increases significantly) due to acceleration of the host vehicle M becomes the reverse of the flow shown in FIG. 2. Moreover, as a condition for applying the present invention to the case where the host vehicle M accelerates, it is assumed that the host vehicle M is an all-wheel-drive vehicle (e.g., because the rear wheels do not slip when the host vehicle M is a front-wheel-drive vehicle).

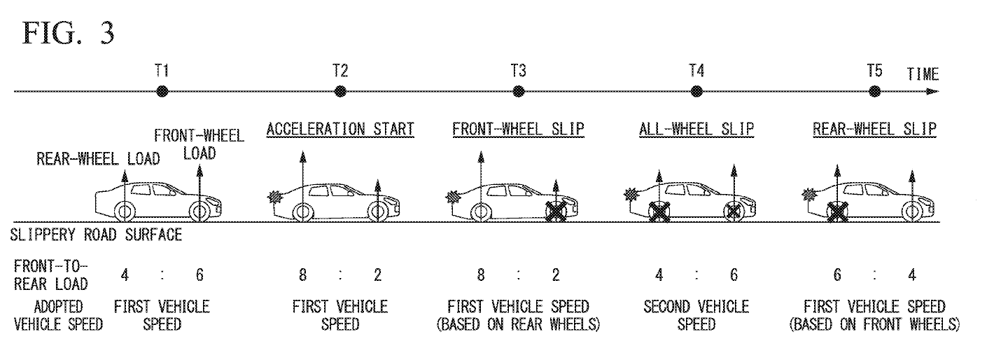

FIG. 3 is an explanatory diagram of a state transition of the host vehicle M and an adopted vehicle speed when all wheels of the host vehicle M spin due to acceleration of the host vehicle M. First, at time point T1, the host vehicle M is assumed to be traveling on a slippery road surface. At this time, the front-to-rear load ratio of the rear wheels to the front wheels applied to the wheels of the host vehicle M is, for example, 4:6, and the vehicle speed determiner 130 adopts the first vehicle speed as the vehicle speed of the host vehicle M. Subsequently, at time point T2, an occupant of the host vehicle M executes an acceleration operation, and it is assumed that the host vehicle M begins to accelerate. At this time, the front-to-rear load ratio of the rear wheels to the front wheels is, for example, 8:2, and the vehicle speed determiner 130 adopts the first vehicle speed as the vehicle speed of the host vehicle M.

Subsequently, at time point T3, it is assumed that the front wheels of the host vehicle M slip due to the low front-to-rear load proportion of the front wheels. At this time, the front-to-rear load ratio of the rear wheels to the front wheels is, for example, 8:2, and the vehicle speed determiner 130 adopts the first vehicle speed based on the wheel speeds of the rear wheels of the host vehicle M as the vehicle speed of the host vehicle M. Subsequently, at time point T4, it is assumed that all wheels of the host vehicle M slip. At this time, the front-to-rear load ratio of the rear wheels to the front wheels is, for example, 4:6, and the vehicle speed determiner 130 adopts the second vehicle speed as the vehicle speed of the host vehicle M.

Subsequently, at time point T5, the slip of the front wheels at time point T3 transitions to the slip of all wheels at time point T4, and the grip of the front wheels of the host vehicle M increases due to the movement of the load from the rear wheels to the front wheels. At this time, because the front-to-rear load ratio of the rear wheels to the front wheels is, for example, 6:4, and the spin of the front wheels of the host vehicle M tends to be released, the vehicle speed determiner 130 adopts the first vehicle speed based on the wheel speed of the front wheels of the host vehicle M as the vehicle speed of the host vehicle M. At this stage, the first vehicle speed based on the wheel speeds of the front wheels of the host vehicle M becomes lower than or equal to the second vehicle speed estimated based on past values of the first vehicle speed before the slip and acceleration, and becomes closer to the actual vehicle speed (which has not accelerated as much as expected due to slipping). That is, according to the present embodiment, when all wheels have slipped due to acceleration of the vehicle, the wheel speed can be utilized early and with high accuracy for estimating the vehicle speed by obtaining the wheel speed from the front wheels during a tendency of release from the spin.

### Processing flow

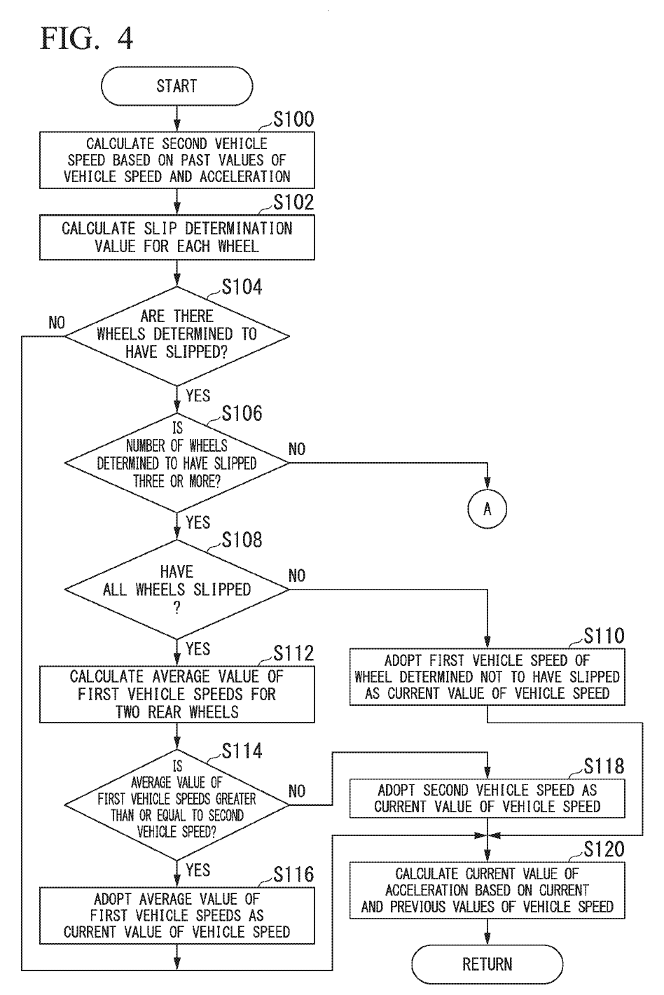

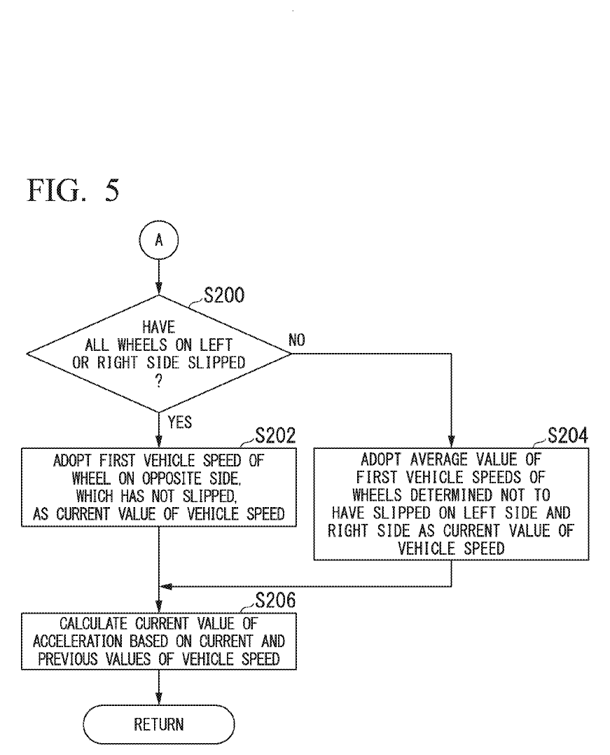

Next, a processing flow according to the embodiment of the present invention will be described with reference to FIGS. 4 and 5. FIG. 4 is a flowchart showing an example of a flow of a process executed by the determination device during braking applied to the host vehicle M. The process of the flowchart shown in FIG. 4 is iteratively executed, for example, while an occupant of the host vehicle M is executing a braking operation.

First, the determination device calculates the second vehicle speed based on past values (previous values) of the vehicle speed and acceleration (step S100). Here, when the flowchart of FIG. 4 is executed for the first time, the vehicle speed used for calculating the second vehicle speed refers to the first vehicle speed (because slip determination has not yet been performed). Subsequently, for each wheel, the determination device calculates a slip determination value, for example, according to the formula (second vehicle speed − first vehicle speed)/second vehicle speed (step S102). Subsequently, the determination device determines whether or not there are wheels determined to have slipped based on whether or not the slip determination value is greater than or equal to a slip determination threshold (step S104). When it is determined that there are no wheels determined to have slipped, the determination device ends the process.

On the other hand, when it is determined that there are wheels determined to have slipped, the determination device determines whether or not there are three or more wheels determined to have slipped (step S106). When it is determined that there are no three or more wheels determined to have slipped, i.e., when it is determined that the number of wheels determined to have slipped is one or two, the determination device executes the process of the flowchart of FIG. 5 to be described below.

When it is determined that there are three or more wheels determined to have slipped, the determination device subsequently determines whether or not all wheels have slipped (step S108). When it is determined that all wheels have not slipped, i.e., when it is determined that the number of wheels determined to have slipped is three, the determination device adopts, as the current vehicle speed of the host vehicle M, the first vehicle speed based on the wheel speed of the wheel determined not to have slipped (step S110). The determination device subsequently moves the process to step S120 to be described below. On the other hand, when it is determined that all wheels have slipped, the determination device calculates an average value of the first vehicle speeds based on the wheel speeds of the two rear wheels (step S112).

Subsequently, the determination device determines whether or not the calculated average value of the first vehicle speeds is greater than or equal to the second vehicle speed (step S114). When it is determined that the calculated average value of the first vehicle speeds is greater than or equal to the second vehicle speed, the determination device adopts the average value of the first vehicle speeds as the current vehicle speed of the host vehicle M (step S116). On the other hand, when it is determined that the calculated average value of the first vehicle speeds is not greater than or equal to the second vehicle speed, the determination device adopts the second vehicle speed as the current vehicle speed of the host vehicle M (step S118). In step S110, S116, or S118, if the current value of the adopted vehicle speed is decided, the determination device calculates the current value of the acceleration, for example, using the formula (current vehicle speed − previous vehicle speed)/elapsed time based on current and previous values of the vehicle speed (step S120). Subsequently, the determination device returns the process to step S100, using the calculated current values of the vehicle speed and acceleration as the previous values. Thereby, the process of the flowchart ends.

FIG. 5 is a flowchart showing an example of the continuation of the processing flow of the flowchart of FIG. 4. The process shown in FIG. 5 is executed when there are no three or more wheels determined to have slipped, i.e., when it is determined that the number of wheels determined to have slipped is one or two, in step S106 of FIG. 4.

The determination device determines whether or not all wheels on the left or right side have slipped (step S200). When it is determined that all wheels on either the left or right side have slipped, this means that all wheels on the opposite side have not slipped. Therefore, the determination device adopts the first vehicle speed of the wheel on the opposite side, which has not slipped, as the current value of the vehicle speed (step S202). In this case, the first vehicle speed based on the wheel speed of one wheel with a predetermined priority between the two wheels, which have not slipped, on the opposite side may be adopted, or the average value of the first vehicle speeds based on the two wheel speeds may be adopted.

When it is determined that all wheels on either the left or right side have not slipped, this means that there is one wheel determined to have slipped on each of the left and right sides (i.e., the total number of wheels determined to have slipped is two), or there is one wheel determined to have slipped on either the left or right side. In this case, the determination device adopts the average value of the first vehicle speeds of the wheels determined not to have slipped on the left and right sides as the current value of the vehicle speed (step S204). Subsequently, the determination device calculates the current value of the acceleration value using a calculation formula similar to that in step S120 based on the current and previous values of the vehicle speed (step S206). Subsequently, the determination device returns the process to step S100, and the calculated current values of the vehicle speed and acceleration are used as the previous values. Thereby, the process of the present flowchart ends.

In addition, the above-described flowcharts of FIGS. 4 and 5 show the processing flow when an occupant of the host vehicle M executes a braking operation. When the occupant of the host vehicle M executes the acceleration operation, the process can be applied by, for example, changing the process for the rear wheels in step S112 to the process for the front wheels, and determining whether or not the average value of the first vehicle speeds is less than or equal to the second vehicle speed in step S114.

Furthermore, in the present embodiment, the host vehicle M has been described as a four-wheeled vehicle as an example. However, the present invention is not limited to this configuration, and can also be applied to a case where the host vehicle M has N wheels (e.g., three wheels), as long as it includes at least front and rear wheels. This is because the front-to-rear load movement of the case where the host vehicle M executes a braking (or acceleration) operation occurs in the flow as described with reference to FIGS. 2 and 3 as in the case where the host vehicle M is a four-wheeled vehicle.

As described above, according to the present embodiment, when all wheels of the host vehicle M become locked due to slipping or the like, the first vehicle speed based on the wheel speeds of the front or rear wheels of the host vehicle M is adopted as the vehicle speed of the host vehicle M at the timing when the wheels tend to unlock. Thereby, when the wheels of the vehicle become locked, the wheel speed can be utilized early and with high accuracy for estimating the vehicle speed.

The embodiment described above can be represented as follows.

A vehicle control device including:

a storage device storing a program; and

a hardware processor,

wherein the hardware processor

calculates a first vehicle speed of a vehicle based on a vehicle speed of the vehicle;

calculates a second vehicle speed that is an estimated speed of the vehicle based on a past value of the calculated first vehicle speed and acceleration of the vehicle;

determines which of the first vehicle speed and the second vehicle speed is to be adopted as the vehicle speed of the vehicle; and

adopts the second vehicle speed as the vehicle speed when all wheels of the vehicle are locked due to braking applied to the vehicle and subsequently adopts the first vehicle speed based on wheel speeds of rear wheels of the vehicle as the vehicle speed of the vehicle when the wheels tend to unlock.

Although modes for carrying out the present invention have been described using embodiments, the present invention is not limited to the embodiments and various modifications and substitutions can also be made without departing from the scope and spirit of the present invention.

What is claimed is:

1. A determination device comprising:
a storage medium storing computer-readable instructions; and
a processor connected to the storage medium, the processor executing the computer-readable instructions to:
calculate a first vehicle speed of a vehicle based on a vehicle speed of the vehicle;
calculate a second vehicle speed that is an estimated speed of the vehicle based on a past value of the calculated first vehicle speed and acceleration of the vehicle; and
determine which of the first vehicle speed and the second vehicle speed is to be adopted as the vehicle speed of the vehicle,
wherein the processor adopts the second vehicle speed as the vehicle speed when all wheels of the vehicle are locked due to braking applied to the vehicle and subsequently adopts the first vehicle speed based on wheel speeds of rear wheels of the vehicle as the vehicle speed of the vehicle when the wheels tend to unlock.

2. The determination device according to claim 1, wherein the processor adopts an average wheel speed of all rear wheels of the vehicle as the first vehicle speed based on the wheel speeds of the rear wheels of the vehicle.

3. The determination device according to claim 1, wherein the processor adopts the first vehicle speed based on the wheel speeds of the rear wheels of the vehicle as the vehicle speed of the vehicle when only the rear wheels of the vehicle are locked due to the braking applied to the vehicle, all wheels of the vehicle are subsequently locked, and the wheels subsequently tend to unlock.

4. The determination device according to claim 1, wherein the processor determines that the wheels tend to unlock to adopt the first vehicle speed based on the wheel speeds of the rear wheels of the vehicle as the vehicle speed of the vehicle when the first vehicle speed based on the wheel speeds of the rear wheels of the vehicle is greater than or equal to the second vehicle speed.

5. The determination device according to claim 4,
wherein the processor calculates the second vehicle speed of the vehicle from the past value of the first vehicle speed before all wheels of the vehicle are locked and the acceleration of the vehicle, and
wherein the processor adopts the vehicle speed based on the wheel speeds of the rear wheels of the vehicle as the first vehicle speed based on the wheel speeds of the rear wheels of the vehicle when the wheels tend to unlock from a state in which all wheels of the vehicle are locked.

6. A determination device comprising:
a storage medium storing computer-readable instructions; and
a processor connected to the storage medium, the processor executing the computer-readable instructions to:
calculate a first vehicle speed of a vehicle based on a vehicle speed of the vehicle;
calculate a second vehicle speed that is an estimated speed of the vehicle based on a past value of the calculated first vehicle speed and acceleration of the vehicle; and
determine which of the first vehicle speed and the second vehicle speed is to be adopted as the vehicle speed of the vehicle,
wherein the processor adopts the second vehicle speed as the vehicle speed when all wheels of the vehicle spin due to the acceleration of the vehicle and subsequently adopts the first vehicle speed based on wheel speeds of front wheels of the vehicle as the speed of the vehicle when the spin tends to be released.

7. A determination method comprising:
calculating, by a computer, a first vehicle speed of a vehicle based on a vehicle speed of the vehicle;
calculating, by the computer, a second vehicle speed that is an estimated speed of the vehicle based on a past value of the calculated first vehicle speed and acceleration of the vehicle;
determining, by the computer, which of the first vehicle speed and the second vehicle speed is to be adopted as the vehicle speed of the vehicle; and
adopting, by the computer, the second vehicle speed as the vehicle speed when all wheels of the vehicle are locked due to braking applied to the vehicle and subsequently adopting the first vehicle speed based on wheel speeds of rear wheels of the vehicle as the vehicle speed of the vehicle when the wheels tend to unlock.

8. A computer-readable non-transitory storage medium storing a program for causing a computer to:
calculate a first vehicle speed of a vehicle based on a vehicle speed of the vehicle;
calculate a second vehicle speed that is an estimated speed of the vehicle based on a past value of the calculated first vehicle speed and acceleration of the vehicle;
determine which of the first vehicle speed and the second vehicle speed is to be adopted as the vehicle speed of the vehicle; and
adopt the second vehicle speed as the vehicle speed when all wheels of the vehicle are locked due to braking applied to the vehicle and subsequently adopt the first vehicle speed based on wheel speeds of rear wheels of the vehicle as the vehicle speed of the vehicle when the wheels tend to unlock.
